(19) United States
(12) Patent Application Publication
(10) Pub. No.: US 2024/0065932 A1
(43) Pub. Date: Feb. 29, 2024

(54) BODYWORK DEVICE

(71) Applicant: Eddie Vaisman, Brooklyn, NY (US)

(72) Inventor: Eddie Vaisman, Brooklyn, NY (US)

(21) Appl. No.: 18/238,480

(22) Filed: Aug. 26, 2023

Related U.S. Application Data
(60) Provisional application No. 63/401,660, filed on Aug. 27, 2022.

(51) Int. Cl. A61H 23/02

(52) U.S. Cl. CPC A61H 23/0254; A61H 2201/0153; A61H 2201/1638

(57) ABSTRACT

A bodywork device adapted for massaging a body part of a user is described in the present invention. The bodywork device includes a handle or a pair of handles having a first end, and a second end. The device includes a massaging head coupled to the second end of the handle. The massaging head includes a massaging insert receivable within a receiving cavity of the massaging head and is adapted to exhibit a rotational motion and/or lateral motion.

### CROSS-REFERENCE TO RELATED APPLICATIONS

The present application hereby claims priority to and incorporates by reference the entirety of the disclosures of the provisional application No. 63/401,660, entitled “A BODYWORK DEVICE” filed on 27 Aug. 2022.

### TECHNICAL FIELD

The present invention generally relates to a physiotherapy device. More particularly, the present invention relates to a bodywork device having a massaging insert that is adapted to exhibit rotational motion and/or lateral motion.

### BACKGROUND

Bodywork devices are well known in the art that are adapted to provide massage therapy to a user. There are various problems that are associated with conventional bodywork devices. One of the problems of conventional devices is that conventional devices are only configured to impart one-directional motion to the massaging inserts, while the user uses the devices to provide massage therapy to his/her body part. Further, the massaging inserts of the conventional devices are not able to cover the maximum area of the body part of the user and therefore require substantial movement of the bodywork device around the body part on which therapy is being performed.

Other limitations of the conventional bodywork devices include improper pressure application at the massaging area i.e., the body part of the user on which the therapy is being performed.

Deep tissue massage involves using intense pressure to relieve muscle pain as it targets deep layers of tissue. However, it is uncomfortable for many users suffering from various medical conditions such as blood clotting disorder, old age, pregnant women, nerve injury, and so on. Conventional bodywork devices do not provide an effective and/or efficient means to provide deep tissue massage.

The above-mentioned limitations of conventional bodywork devices restrict the commercial deployment of said devices. In an attempt to scale up the use of physiotherapy devices, for example, bodywork devices, there remains a need for a bodywork device that is capable of solving the aforementioned problems of conventional bodywork devices.

### SUMMARY

Disclosed is a bodywork device adapted for massaging a body part of a user, comprising: at least one handle comprising a first end, and a second end; and a massaging head coupled to the second end of the handle, the massaging head comprising: a massaging insert received within a receiving cavity of the massaging head and is adapted to exhibit a rotational motion and/or lateral motion.

Various other features, aspects, and advantages of the present invention will become more apparent from the following detailed description of the embodiments of the invention, along with the accompanying drawings in which like numerals represent like components.

### BRIEF DESCRIPTION OF THE DRAWINGS

In the drawings:

FIG. 1 illustrates a perspective view of a bodywork device, according to an exemplary embodiment of the present invention;

FIG. 2 illustrates a perspective view of a first massaging insert, according to an embodiment of the present invention;

FIG. 3 illustrates a perspective view of a second massaging insert, according to an embodiment of the present invention; and

FIG. 4 illustrates a perspective view of a bodywork device with a flexible neck portion, according to another embodiment of the present invention;

FIG. 5 illustrates a perspective view of a bodywork device, according to another embodiment of the present invention; and

FIG. 6 illustrates a perspective view of the bodywork device of FIG. 5 wherein the massaging insert is coupled to the massaging head.

### DETAILED DESCRIPTION

Before describing the present invention in detail, it should be observed that the present invention utilizes a combination of components or processes, which constitutes a bodywork device for a user. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation.

The terms “yawing” and “pitching” as used herein in the context of the present disclosure shall be referred or defined as the general meaning associated with said terms, as known for the conventional elements of the similar devices.

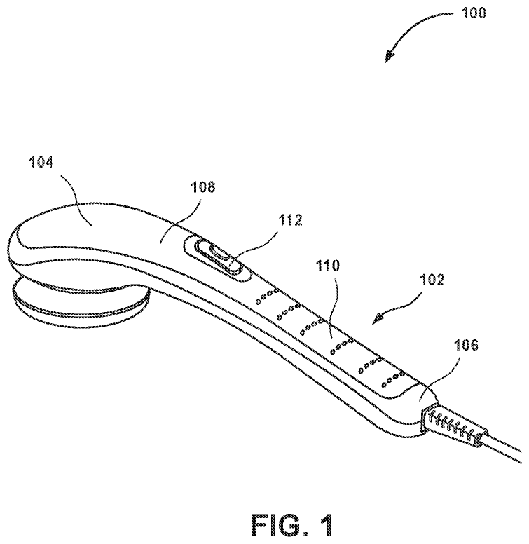

The bodywork device will now be described with reference to the accompanying drawings, particularly FIGS. 1-6.

FIG. 1 illustrates a bodywork device 100 configured to provide massage therapy to a user. The bodywork device 100 may include a handle 102 and a massaging head 104. The handle 102 may further include a first end 106, a second end 108, and a grip portion 110. The handle 102 may substantially extend from the first end 106 to the second end 108 through the grip portion 110 such that the grip portion 110 lies between the first end 106 and the second end 108. The massaging head 104 may be coupled to the second end 108 of the handle 102. The massaging head 104 may be integrally or removably coupled to the second end 108 of the handle 102 The grip portion 110 may be adapted to facilitate the user to hold the bodywork device 100 in the hands of the user. The first end 106 of the handle 102 may be adapted to facilitate passing a cord through the handle 102 such that the cord is connected to a power supply source (not shown). The power supply source may be adapted to provide the necessary power to the bodywork device 100. The massaging head 104 may further include a receiving cavity (not shown) and a shaft (not shown). The shaft may extend outward from the receiving cavity of the massaging head 104. The receiving cavity of the massaging head 104 may be adapted to receive massaging inserts 200 or 300 such that the massaging inserts 200 or 300 are coupled to the shaft of the massaging head 104. The massaging inserts 200 or 300 will be described in detail in the description to follow.

In some embodiments, a switch 112 may be disposed at the grip portion 110 of the handle 102 of the bodywork device 100. The switch 112, when activated may be adapted to complete the power circuit within the bodywork device 100 that energizes the shaft of the massaging head 104. The switch 112, when deactivated may be adapted to break the power circuit within the bodywork device 100 that de-energizes the shaft of the massaging head 104. The user, therefore, has a choice of selectively activating and deactivating the switch 112 to selectively energizing and de-energizing the shaft of the massaging head 104, respectively.

In some embodiments, the grip portion 110 may exhibit a grip patch (not shown). The grip patch may be formed by providing ridges at a predefined region of the grip portion 110 such that the grip portion 110 facilitates the user to efficiently hold the bodywork device 100, while the user provides massage therapy to any of its body parts.

In some embodiments, the bodywork device 100 is battery powered. The handle 102 of the bodywork device 100 could include at least one rechargeable and/or removable battery (not shown in figures), thus enabling the user to use the bodywork device 100 at locations where electricity is not readily accessible.

In operation, the massaging insert (200, 300) may be adapted to exhibit a rotational motion and/or lateral motion, while the user is providing massage therapy to its body part. The lateral motion and the rotational motion of the massaging insert (200, 300) may be adapted to exhibit in the same plane. The term lateral motion as used herein refers to the to and fro motion in a direction perpendicular to the massaging insert (200, 300) and the term rotational motion as used herein refers to the eccentric rotational motion of the massaging insert (200, 300). The shaft of the massaging head 104 may be adapted to exhibit lateral motion that is to and fro motion in a direction perpendicular to the massaging insert (200, 300), which facilitates the massaging head 104 to exhibit lateral motion. The massaging insert (200, 300) may be eccentrically disposed of with respect to the shaft such that the shaft, when rotated may result in facilitating eccentric rotation of the massaging insert (200, 300).

In some embodiments, the bodywork device 100 may include a speed regulator (not shown in the figures). In an example, the speed regulator (not shown in the figures) could be in the form of a rotary dial. The speed regulator may be adapted to adjust or regulate the speed of the shaft of the massaging insert (200, 300) while the massaging insert (200, 300) exhibits rotational motion and/or lateral motion. In some examples, the speed regulator may be enabled as a lockable slider such that the slider is adapted to adjust or regulate a required speed of the shaft of the massaging insert (200, 300). The speed regulator further includes a lock (not shown in figures) such that when lock is enabled, the speed of the shaft of the massaging insert (200, 300) is maintained at a constant value. In an example, the lock (not shown in the figures) could be in the form of a lock-on switch.

In some embodiments, the massaging insert (200, 300) is adapted to exhibit the lateral and rotational motions simultaneously thus producing an orbital motion that enhances the effect of the massaging insert (200, 300) while the bodywork device 100 performs massaging operation.

In some embodiments, the massaging insert (200, 300) may be adapted to exhibit only lateral motion.

In some embodiments, the massaging insert (200, 300) may be adapted to exhibit only rotational motion.

In some embodiments (not shown in figures), the massaging head 104 comprises a glove like massaging insert that may be deployed on the massaging head 104 in a glove wearing—fashion. The user can apply (wear) massaging insert on the massaging head 104 by using their hand(s) substantially mimicking wearing a conventional glove on one hand by using their other hand.

In some embodiments, the massaging head 104 may be adapted with a Velcro or sticker-like mechanism that facilitates the massaging head 104 to stick onto a suitable massaging insert in the form of a pad. The massaging insert in the form of a pad may then be traversed across the skin of the user to perform the massaging operation.

In embodiment as seen in FIG. 1, one handle 102 is provided in the bodywork device 100. However, in other embodiments (not shown in figures), the number of handles in the bodywork device 100 could be more than one such as but not limited to two, three, four, and so on.

In an exemplary embodiment (not shown in figures), the bodywork device 100 comprises two handles 102 which consists of one primary handle and one secondary handle. The provision of the secondary handle allows better grip control to enable efficient massaging operation. In an embodiment (not shown in figures), the secondary handle is located at an angular distance of 180 degrees with respect to the primary handle. In various other embodiments (not shown in figures), the angular distance between the secondary handle and the primary handle could be any angular degree such as but not limited to 45 degree, 90 degree, 135 degree and so on.

In some embodiments, while performing massage therapy on the body part of the user, a sheet (not shown) may be disposed of between the massaging insert (200, 300) of the bodywork device 100 and the body part of the user. The sheet may be laminated with a layer of wax. The layer of wax adds fluffiness to the sheet, which causes comfort to the user during massage therapy when the sheet is placed between the massaging insert (200, 300) and the body part of the user. In some embodiments, the massaging insert (200, 300) may be provided with a layer of sheet coated with wax, which eliminates the need for a sheet. During massage therapy, the sheet may be fitted on the body part of the user. In some examples, the edges of the sheet may be suitably held to prevent the sheet from getting pulled, while the bodywork device 100 performs massage therapy on the body part of the user. In some other examples, markings, temporary liquids, tattoos, make-up, and massage oils from the body part of the user may be covered to safeguard the massaging insert (200, 300), while the bodywork device 100 performs massage on the body.

In some embodiments, the massaging insert (200, 300) may be thin to maximize the effect of the massaging insert (200, 300), while the bodywork device 100 performs massage therapy on the body part of the user.

In some embodiments, the massaging insert 200 or 300 is configured to deep massage muscles due to the gentle vibrational-based motion effect of massaging head 104.

In some embodiments, the massaging insert (200, 300) may be covered with an abrasive sheet (abrasive layer). The abrasive sheet of the massaging insert (200, 300) may be configured to exfoliate the skin, particularly but not limited to harsh areas such as the feet.

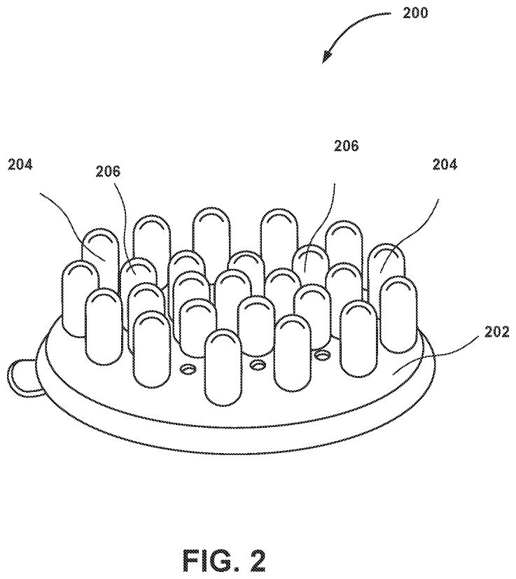

FIG. 2 illustrates a perspective view of a first massaging insert 200. The first massaging insert 200 may include a first base 202, a plurality of first protrusions 204, a plurality of second protrusions 206. Each protrusion of the plurality of first protrusions 204 and each protrusion of the plurality of second protrusions 206 may be adapted to extend upwardly from the first base 202. The plurality of first protrusions 204 may be adapted to surround the plurality of second protrusions 206. The first massaging insert 200 may be adapted to receive within the receiving cavity of the massaging head 104. The first massaging insert 200 may be coupled to the shaft of the massaging head 104 such that the first massaging insert 200 may be adapted to exhibit the rotational motion and/or lateral motion. The plurality of first protrusions 204 and the plurality of second protrusions 206 may be adapted to relieve pain or strain from the body part of the user, on which the massaging therapy is performed.

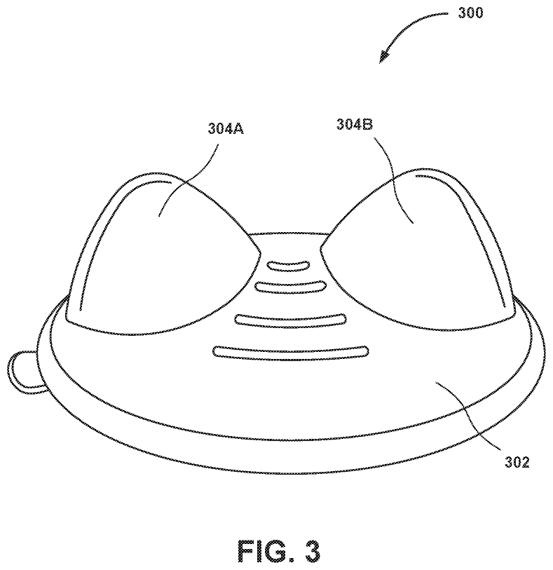

FIG. 3 illustrates a perspective view of a second massaging insert 300. The second massaging insert 300 may include a second base 302, a pair of protrusions 304A and 304B. Each protrusion of the pair of protrusions 304A and 304B may be adapted to extend upwardly from the second base 302. The second massaging insert 300 may be adapted to receive within the receiving cavity of the massaging head 104. The second massaging insert 300 may be coupled to the shaft of the massaging head 104 such that the second massaging insert 300 may be adapted to exhibit the rotational motion and/or lateral motion. The pair of protrusions 304A and 304B may be adapted to relieve pain or strain from the body part of the user, on which the massaging therapy is performed.

In some embodiments, the first massaging insert 200 and the second massaging insert 300 may be coated with a layer of wax sheet. The wax sheet of the first and massaging inserts 200 and 300 may increase the smoothness between the first and second massaging inserts 200 and 300 and the body part of the user. The wax sheet, therefore, adds on pleasant experience to the user, while the bodywork device 100 performs massage therapy on the body part of the user.

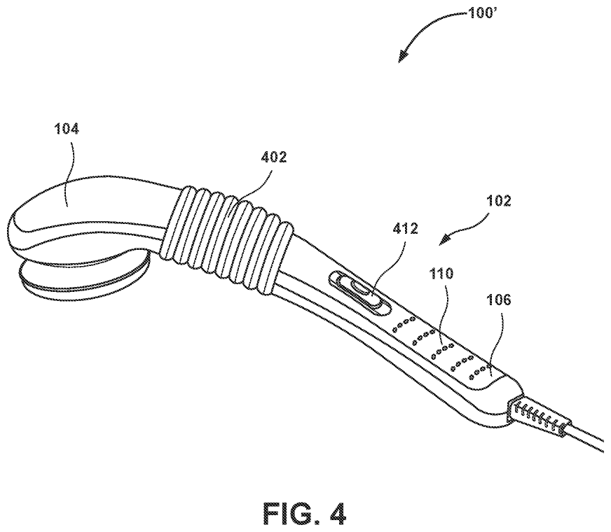

FIG. 4 illustrates a bodywork device 100′ in accordance with another embodiment of the present invention. The bodywork device 100′ is pretty similar to the bodywork device 100 as shown in FIG. 1 except with geometric modifications associated with the flexible neck portion. The bodywork device 100′ may be provided with a flexible neck portion 402. Like elements of the bodywork device 100 bears like numerals for the bodywork device 100′. For example, if an element is provided in bodywork device 100 and in the bodywork device 100′, then the element of the bodywork device 100′ of FIG. 2 bears like reference numerals as referred in the bodywork device 100 of FIG. 1. Furthermore, like elements of the bodywork device 100 exhibits similar positioning/placement/coupling/connection as the elements of the bodywork device 100′ of FIG. 2. The flexible neck portion 402 may be adapted to dispose between the first end 106 of the handle 102 and the massaging head 104. The flexible neck portion 402 may facilitate the massage head 104 to exhibit multiple degrees of freedom. For example, the flexible neck portion 402 may be adapted to facilitate the massage head 104 to exhibit yawing and pitching motion. The flexible neck portion 402 may therefore be adapted to cover the maximum area of the body part on which the massage therapy is performed.

The switch 412 may be disposed at the grip portion of the handle 102 of the bodywork device 100′. The switch 412 is similar to switch 112 as shown in FIG. 1 except with added functionality of controlling the flexible neck portion 402. The switch 412 is configured to manually control the flexibility of the flexible neck portion 402 depending on the user's requirements.

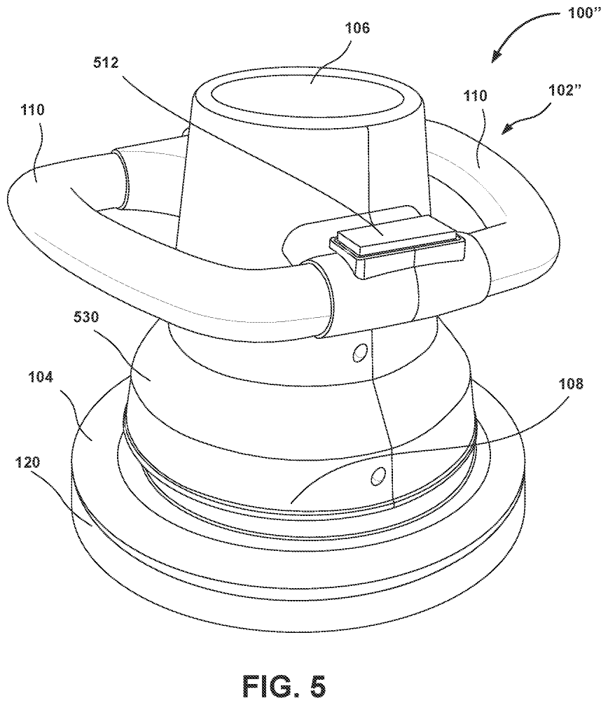

FIG. 5 illustrates a bodywork device 100″ in accordance with another embodiment of the present invention. The bodywork device 100″ is pretty similar to the bodywork device 100 as shown in FIG. 1 except with geometric modifications associated with the handle and electric power arrangement. Like elements of the bodywork device 100 bears like numerals for the bodywork device 100′. For example, if an element is provided in bodywork device 100 and in the bodywork device 100″, then the element of the bodywork device 100″ of FIG. 5 bears like reference numerals as referred in the bodywork device 100 of FIG. 1.

FIG. 5 illustrates a bodywork device 100″ that is configured to provide a massage therapy to the user. The bodywork device 100″ may include a handle 102″ and a massaging head 104. The handle 102″ may further include a first end 106, a second end 108, and a pair of grip portions 110. The handle 102 may substantially extend from the first end 106 to the second end 108 through the pair of grip portions 110 such that the pair of grip portions 110 lies between the first end 106 and the second end 108. The pair of grip portions 110 may be adapted to facilitate a user to hold the bodywork device 100 in the hands of the user. The pair of grip portions 110 are configured such that the human user can grasp the bodywork device 100″ by placing one hand on the first grip portion 110 and the other hand on the second grip portion 110. The massaging head 104 may be coupled to the second end 108 of the handle 102. The massaging head 104 may further include a peripheral wall 120 and a shaft (not shown). The shaft (not shown) is connected to the peripheral wall 120 of the massaging head 104. The peripheral wall 120 of the massaging head 104 may be adapted to receive a massaging insert such that the massaging insert is rotatably coupled to the peripheral wall 120 of the massaging head 104.

The bodywork device 100″ is battery-powered. The handle 102″ of the bodywork device 100″ includes a storage compartment 530 that comprises at least one rechargeable and/or removable battery (not shown in figures), thus enabling the user to use the bodywork device 100″ at locations where electricity is not readily accessible. The switch 512 may be disposed at the junction of the pair of the grip portions 110 of the handle 102″ of the bodywork device 100″. The switch 512 is similar to switch 112 as shown in FIG. 1.

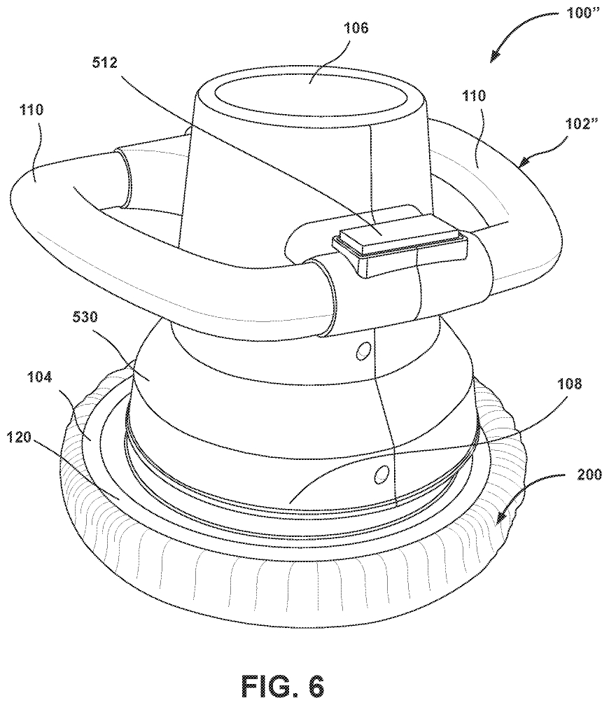

FIG. 6 illustrates a perspective view of a bodywork device 100″ wherein the massaging insert (200, 300) is coupled to the massaging head 100″.

Certain advantages of the bodywork device (100, 100′, 100″) of the present disclosure are listed herein below: —
The bodywork device (100, 100′, 100″) facilitates proper pressure or force application at the region of the body part on which the massage therapy is performed.
The flexible neck portion 402 of the bodywork device 100′ may be adapted to increase the reach of the massaging head 104 around the body part of the user on which the massage therapy is being performed.
The bodywork device (100, 100′, 100″) may be adapted to provide relaxing massage therapy to the body part of the user, because of the ability of the massaging insert to exhibit the rotational motion and/or lateral motion.
The layer of a wax sheet on the first and second massaging inserts 200 and 300 enhances smoothness between the first and second massaging inserts 200 and 300 and the body part of the user, which provides a pleasant experience to the user, while the bodywork device (100, 100′, 100″) performs massage therapy on the body part of the user.
The bodywork device (100, 100′, 100″) may be adapted to provide relaxing massage therapy to the body part of the user, because of the ability of the massaging insert to exhibit the rotational motion and/or lateral motion.

The various components and parts of the various embodiments of the bodywork device (100, 100′, 100″) of the present invention is similar and interchangeable. It is obvious to the one skilled in the art that the various components, parts of the bodywork device (100, 100′, 100″) of one embodiment of the present invention could be considered for other embodiments with little or no variation.

It should be understood according to the preceding description of the present invention that the same is susceptible to changes, modifications, and adaptations and that the said changes, modifications, and adaptations fall within the scope of the appended claims.

What is claimed is:

1. A bodywork device adapted for massaging a body part of a user, comprising:
at least one handle comprising a first end, and a second end; and
a massaging head coupled to the second end of the handle, the massaging head comprising:
a massaging insert received within a receiving cavity of the massaging head and is adapted to exhibit a rotational motion and/or lateral motion.

2. The bodywork device of claim 1, wherein the handle comprises at least one grip portion.

3. The bodywork device of claim 1, wherein the bodywork device is powered using a power source.

4. The bodywork device of claim 1, wherein the massaging insert is coupled to a shaft extending outward from the receiving cavity of the massaging head.

5. The bodywork device of claim 1 further comprising a switch that's selectively activated and deactivated to energize and de-energize the shaft of the massaging head.

6. The bodywork device (100) of claim 1 further comprising a grip patch on the at least one grip portion and is formed by providing ridges at a predefined region of the at least one grip portion such that the at least one grip portion facilitates the user to efficiently hold the bodywork device.

7. The bodywork device of claim 1, wherein the lateral motion of the massaging insert is to and fro motion in a direction perpendicular to the massaging insert.

8. The bodywork device of claim 1, wherein the rotational motion of the massaging insert is an eccentric rotational motion.

9. The bodywork device of claim 1 further comprising a speed regulator in the form of a rotary dial adapted to adjust the speed of the shaft of the massaging insert while the massaging insert exhibits the rotational motion and/or lateral motion.

10. The bodywork device of claim 1, wherein the speed regulator is enabled as a lockable slider and is adapted to adjust or regulate the required speed of the shaft of the massaging insert.

11. The bodywork device of claim 1, wherein massaging insert is a glove-like massaging insert deployable on the massaging head in a glove-wearing fashion.

12. The bodywork device of claim 1, wherein the at least one handle comprises a primary handle and one secondary handle that allows better grip control to enable efficient massaging operation.

13. The bodywork device of claim 12, wherein the secondary handle is located at an angular distance of about 45 degrees, 90 degrees, 135 degrees, or 180 degrees with respect to the primary handle.

14. The bodywork device of claim 1 further comprising a sheet laminated with a layer of wax and disposable between the massaging insert of the bodywork device and the body part of the user.

15. The bodywork device of claim 1, wherein the massaging insert is configured to deep massage muscles due to the vibrational-based motion of the massaging head.

16. The bodywork device of claim 1, wherein the massaging insert is covered with an abrasive sheet to exfoliate the skin of the user.

17. The bodywork device of claim 1, wherein the massaging insert comprising:
a first base;
a plurality of first protrusions;
a plurality of second protrusions, wherein each protrusion of the plurality of first protrusions and the plurality of second protrusions extends upwardly from the first base; and
wherein the plurality of first protrusions surrounds the plurality of second protrusions.

18. The bodywork device of claim 1, wherein the massaging insert comprising:
a second base; and
a pair of protrusions and, each protrusion of the pair of protrusions extends upwardly from the second base.

19. The bodywork device of claim 1, wherein the bodywork device is provided with a flexible neck portion to facilitate the massage head to exhibit yawing and pitching motion to cover the maximum area of the body part on which the massage therapy is performed.

20. The bodywork device of claim 1, wherein the handle extends from the first end to the second end through the at least one grip portion.

21. The bodywork device of claim 1, wherein the massaging head further comprises a peripheral wall, wherein the peripheral wall of the massaging head is adapted to receive massaging insert rotatably coupled to the peripheral wall; and a shaft connected to the peripheral wall of the massaging head.
